(19) United States
(12) Patent Application Publication
(10) Pub. No.: US 2016/0125537 A1
(43) Pub. Date: May 5, 2016

(54) PORTFOLIO MANAGEMENT

(71) Applicants: Theodore Tsung, Old Westbury, NY (US); Jessica Liu, Old Westbury, NY (US)

(72) Inventors: Theodore Tsung, Old Westbury, NY (US); Jessica Liu, Old Westbury, NY (US)

(21) Appl. No.: 14/527,360

(22) Filed: Oct. 29, 2014

(51) Int. Cl. G06Q 40/06

(52) U.S. Cl. CPC G06Q 40/06

(57) ABSTRACT

A method and system are provided. The method includes calculating respective moving average values for client holdings at a financial account level, an individual client level, and a household level based on end-of-day holding prices therefor. The method further includes calculating a financial account level risk metric, an individual level risk metric, and a household level risk metric responsive to the respective moving average values. The method also includes outputting a respective alarm signal for at least one financial firm employee responsive to any of the financial account level risk metric, the individual level risk metric, and the household level risk metric respectively exceeding a target financial account level risk metric, a target individual level risk metric, and a target household level risk metric. The target risk metrics are determined from respective client specified risk acceptance values at the financial account level, the individual client level, and the household level.

### BACKGROUND

1. Technical Field

The present invention relates generally to financial accounts and, in particular, to portfolio management.

2. Description of the Related Art

The management of financial portfolios is a difficult and time-consuming task requiring constant oversight in order to prevent undesirable losses on a number of levels, such as an individual account level, an individual level, and a household level. Thus, a need exists for an efficient and accurate way to ascertain impending portfolio loss and to provide a way to indicate the same in a meaningful way that results in prevention of such loss.

### SUMMARY

According to an aspect of the present principles, a method is provided. The method includes calculating, using a processor-based moving average model generator, respective moving average values for client holdings at a financial account level, an individual client level, and a household level based on end-of-day holding prices therefor. The method further includes calculating a financial account level risk metric, an individual level risk metric, and a household level risk metric responsive to the respective moving average values. The method also includes outputting a respective machine-generated alarm signal for at least one financial firm employee responsive to any of the financial account level risk metric, the individual level risk metric, and the household level risk metric respectively exceeding a target financial account level risk metric, a target individual level risk metric, and a target household level risk metric. The target risk metrics are determined from respective client specified risk acceptance values at the financial account level, the individual client level, and the household level.

According to another aspect of the present principles, a system is provided. The system includes a processor-based moving average model generator for calculating respective moving average values for client holdings at a financial account level, an individual client level, and a household level based on end-of-day holding prices therefor. The system further includes a risk performance calculator for calculating a financial account level risk metric, an individual level risk metric, and a household level risk metric responsive to the respective moving average values. The system also includes an alarm generator for outputting a respective alarm signal for at least one financial firm employee responsive to any of the financial account level risk metric, the individual level risk metric, and the household level risk metric respectively exceeding a target financial account level risk metric, a target individual level risk metric, and a target household level risk metric. The target risk metrics are determined from respective client specified risk acceptance values at the financial account level, the individual client level, and the household level.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a high-level block diagram showing an exemplary architecture 100 to which the present principles can be applied, in accordance with an embodiment of the present principles;

FIG. 2 is a block diagram showing an exemplary data processing system 200 to which the present principles may be applied, in accordance with an embodiment of the present principles;

FIG. 3 is a block diagram showing an exemplary data processing system 300 for portfolio risk management, in accordance with an embodiment of the present principles;

FIGS. 4-6 are flow diagrams showing an exemplary method 400 for managing portfolio risk, in accordance with an embodiment of the present principles;

FIG. 7 is a flow diagram further showing step 430 of FIG. 4, in accordance with an embodiment of the present principles;

FIG. 8 is a flow diagram further showing step 435 of FIG. 4, in accordance with an embodiment of the present principles; and

FIG. 9 is a flow diagram further showing step 440 of FIG. 4, in accordance with an embodiment of the present principles.

### DETAILED DESCRIPTION OF PREFERRED EMBODIMENTS

The present principles are directed to portfolio management.

The present principles provide a data processing system and corresponding method to monitor daily portfolio risk threshold across any size financial service firm with financial advisers who oversee investor clients' assets. In an embodiment, the present principles can compute likelihood of portfolio loss based on a moving average model versus respective client defined risk thresholds at the financial account level, the financial account owner level (defined as the financial account primary account holder), and the household level (defined by grouping primary account holders together). In an embodiment, when one or more of the respective client defined risk thresholds are crossed, a series of alert workflows can be applied to and/or otherwise generated for one or more of the financial advisor, the manager, and the risk/compliance officer, to ensure timely financial account holding review.

The data processing system is designed to compute financial advisor risk triggered at, for example, but not limited to, the following time bases: weekly; monthly; quarterly; and annually. Of course, other time bases can also be used in accordance with the teachings of the present principles, while maintaining the spirit of the present principles. In an embodiment a same period last quarter and last year comparison can be made to determine the risk performance of a financial advisor, manager, and risk/compliance officer so that the firm can determine the overall client portfolio risk metric at the firm level.

The ultimate objective of the data processing system and method of the present principles is to prevent heavy client portfolio loss via a computerized computation model and corresponding risk alert mechanism. The financial firm management and/or some other entity can measure the frequency of risk alerts triggered by the financial advisor, manager, and risk/compliance officer, to determine their effectiveness in regard to client asset protection and monitoring.

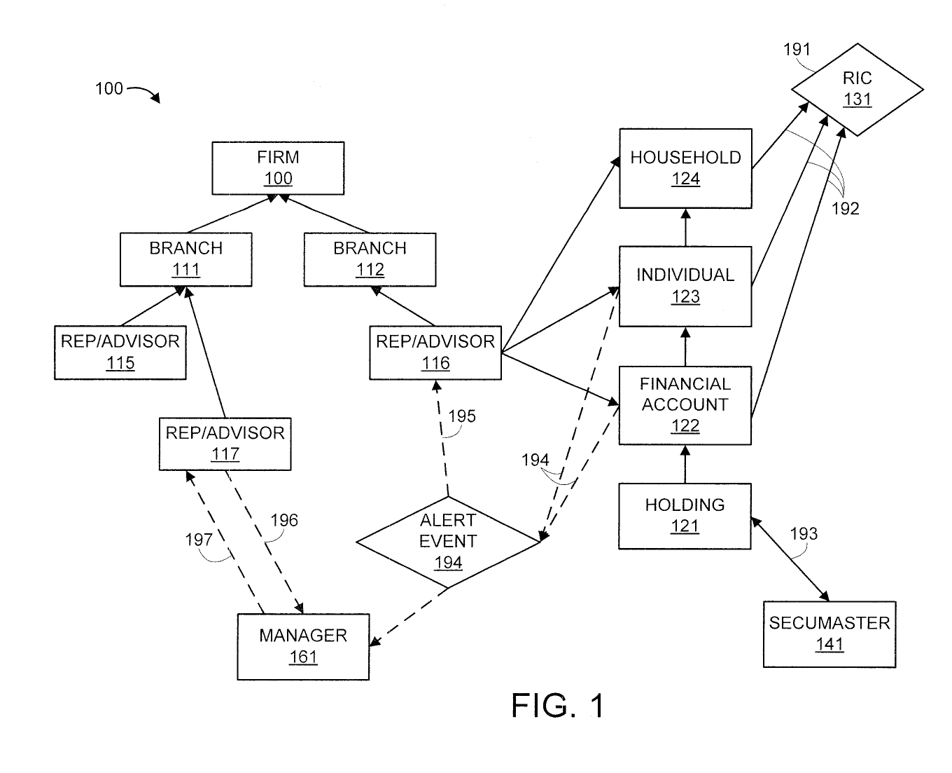

FIG. 1 is a high-level block diagram showing an exemplary architecture 100 to which the present principles can be applied, in accordance with an embodiment of the present principles. The architecture 100 includes a financial firm 100 that has multiple branches 111, 112, and multiple financial representatives/financial advisors (“rep/advisor”) 115, 116, and 117. The architecture 100 further includes holding data 121, financial account data 122, individual data 123, and household data 124. Moreover, the architecture 100 involves a Risk Index Code (RIC) 131, a SecurityMaster (also interchangeably referred to herein as “SecuMaster”) 141, and an alert event 151 having respective purposes defined in detail herein below. A manger 161 (e.g., compliance officer (CO), chief compliance officer (CCO) or other individual) is involved in defining a risk metric as well as reviewing and approving or disapproving an exception implicated by the alert event 194.

Some details regarding the present principles will now be described with respect to FIG. 1. However, it is to be appreciated that further details are provided herein below. At step 191, the manager 161 defines a risk metric. At step 192, the rep/advisor 115, 116, or 117 defines a risk metric per client and per financial account. In this embodiment, step 192 also involves the rep/advisor 115, 116, or 117 defining a risk per household. At step 193, the SecuMaster 141 is updated with the current risk on some time basis (e.g., but not limited to, nightly). At step 194, the alert event is generated. At step 195, a rep/advisor 115, 116, or 117 receives the alert event 194 by email. Of course, other communication mechanism can be used in addition to or in place of an email including, but not limited to, a voicemail, a text message, and so forth. At step 196, the rep/advisor 115, 116, or 117 submits an exception for approval/disapproval to the manager 161. The exception relates to the alert event 194. At step 197, the manager 161 reviews and approves or disapproves the exception.

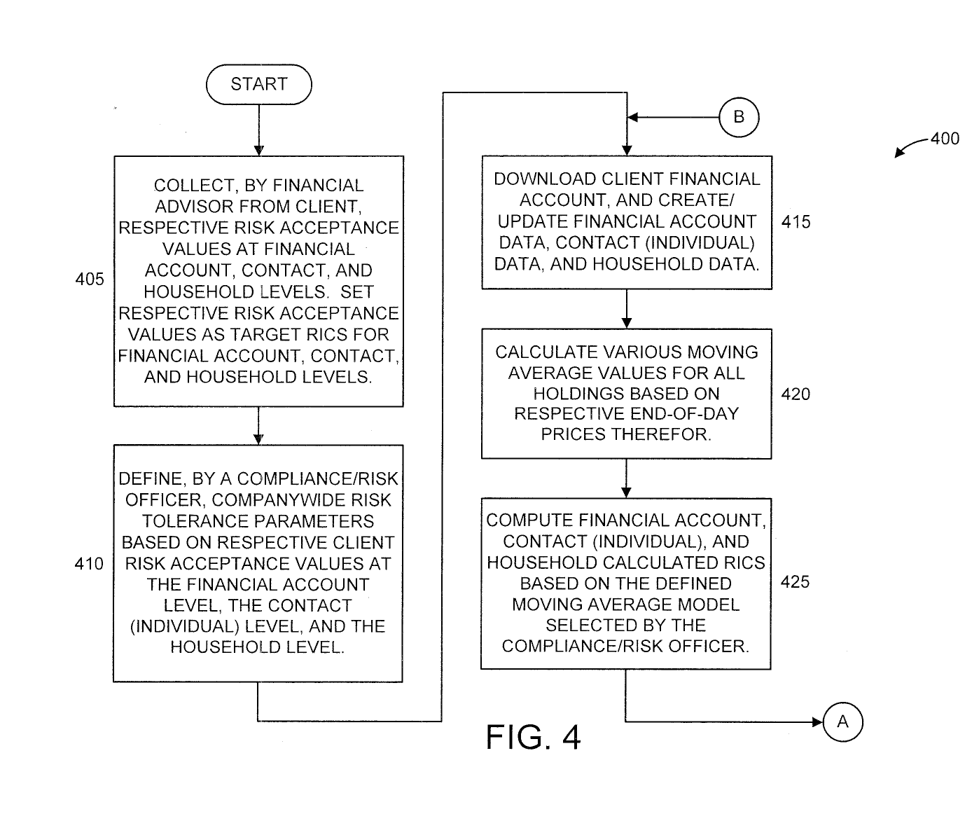

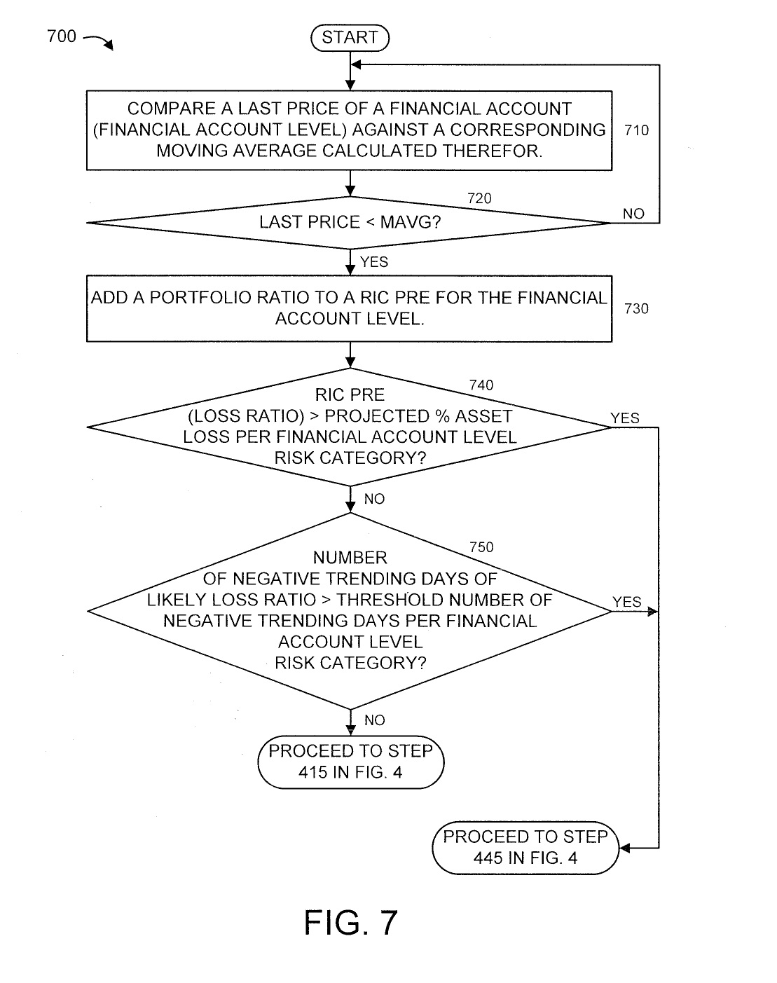

Regarding the terms “Risk Index Code” or RIC 131, the same refer to one or more particular data items that are used as respective bases for generating alert events 194. RICs are category or level specific in that RICs can be generated on a per financial account basis, an individual basis, and a household basis. Thus, a given RIC usually applies to a given category and, thus, multiple RICs can be used in accordance with the present principles to cover multiple categories. RICs are used generally in the method 400 of FIG. 4, but more specific examples of RICs are used with respect to FIGS. 7-9.

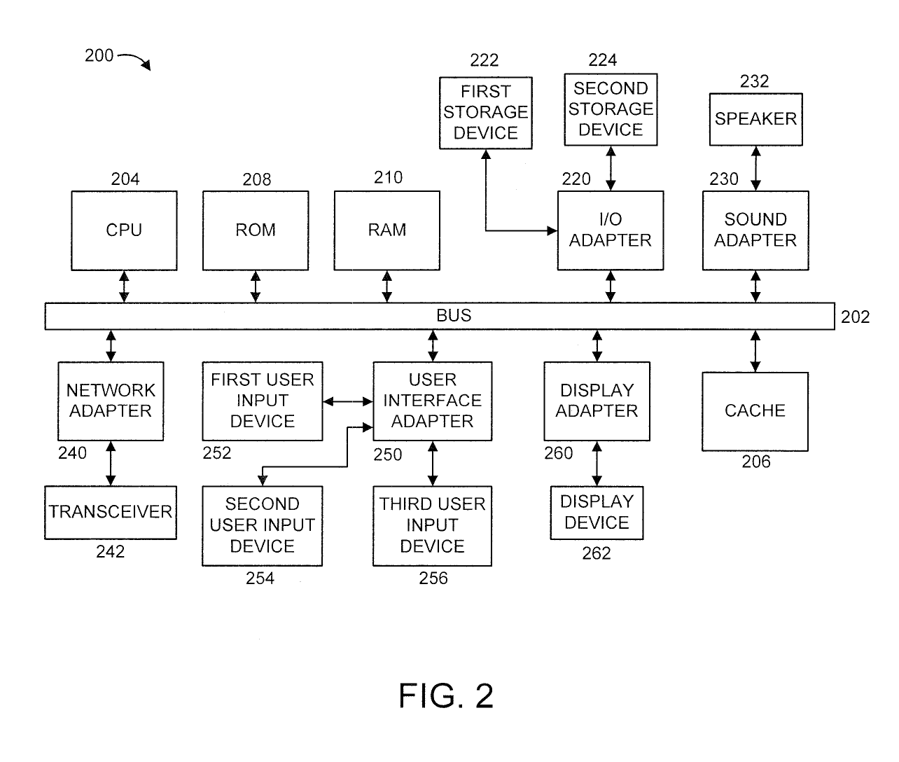

FIG. 2 is a block diagram showing an exemplary data processing system 200 to which the present principles may be applied, in accordance with an embodiment of the present principles. The processing system 200 includes at least one processor (CPU) 204 operatively coupled to other components via a system bus 202. A cache 206, a Read Only Memory (ROM) 208, a Random Access Memory (RAM) 210, an input/output (I/O) adapter 220, a sound adapter 230, a network adapter 240, a user interface adapter 250, and a display adapter 260, are operatively coupled to the system bus 202.

A first storage device 222 and a second storage device 224 are operatively coupled to system bus 202 by the I/O adapter 220. The storage devices 222 and 224 can be any of a disk storage device (e.g., a magnetic or optical disk storage device), a solid state magnetic device, and so forth. The storage devices 222 and 224 can be the same type of storage device or different types of storage devices.

A speaker 232 is operative coupled to system bus 202 by the sound adapter 230.

A transceiver 242 is operatively coupled to system bus 202 by network adapter 240.

A first user input device 252, a second user input device 254, and a third user input device 256 are operatively coupled to system bus 202 by user interface adapter 250. The user input devices 252, 254, and 256 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 252, 254, and 256 can be the same type of user input device or different types of user input devices. The user input devices 252, 254, and 256 are used to input and output information to and from system 200.

A display device 262 is operatively coupled to system bus 202 by display adapter 260.

Elements of system 200 such as, but not limited to, speaker 232 and display device 262 can be used to provide the alert event 194 described herein. For example, the display device 262 can display an email or other form of message that includes and/or otherwise provides notice of the alert event 194.

Of course, other elements can be used in place of, or in addition to, any of the preceding elements, in order to provide the alert event 194 to the one or more individuals designated to receive the alert event 194.

Hence, of course, the processing system 200 may also include other elements (not shown), as readily contemplated by one of skill in the art, as well as omit certain elements. For example, various other input devices and/or output devices can be included in processing system 200, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 200 are readily contemplated by one of ordinary skill in the art given the teachings of the present principles provided herein.

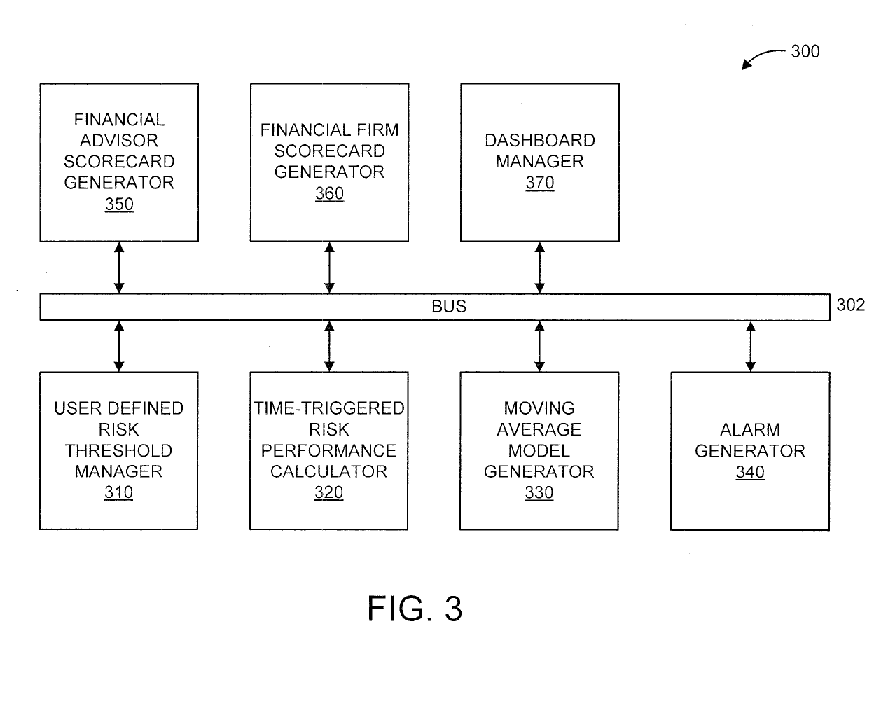

Moreover, it is to be appreciated that system 300 described below with respect to FIG. 3 is a system for implementing respective embodiments of the present principles. Part or all of processing system 200 may be implemented in one or more of the elements of system 300.

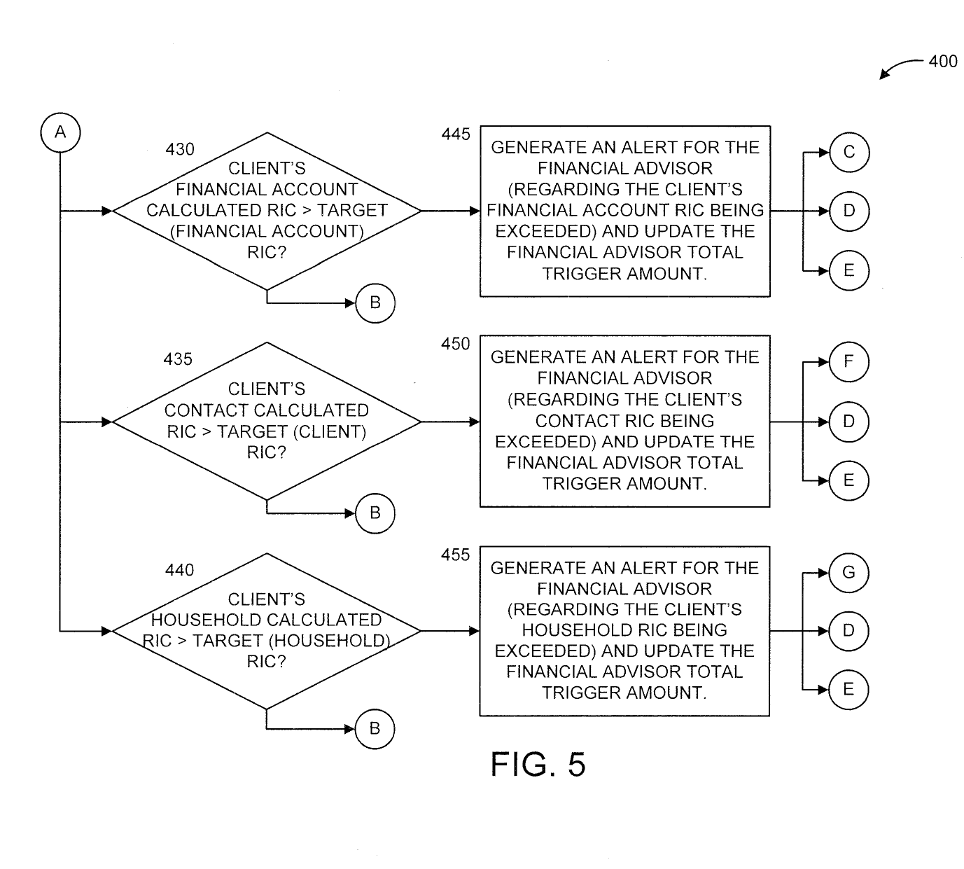

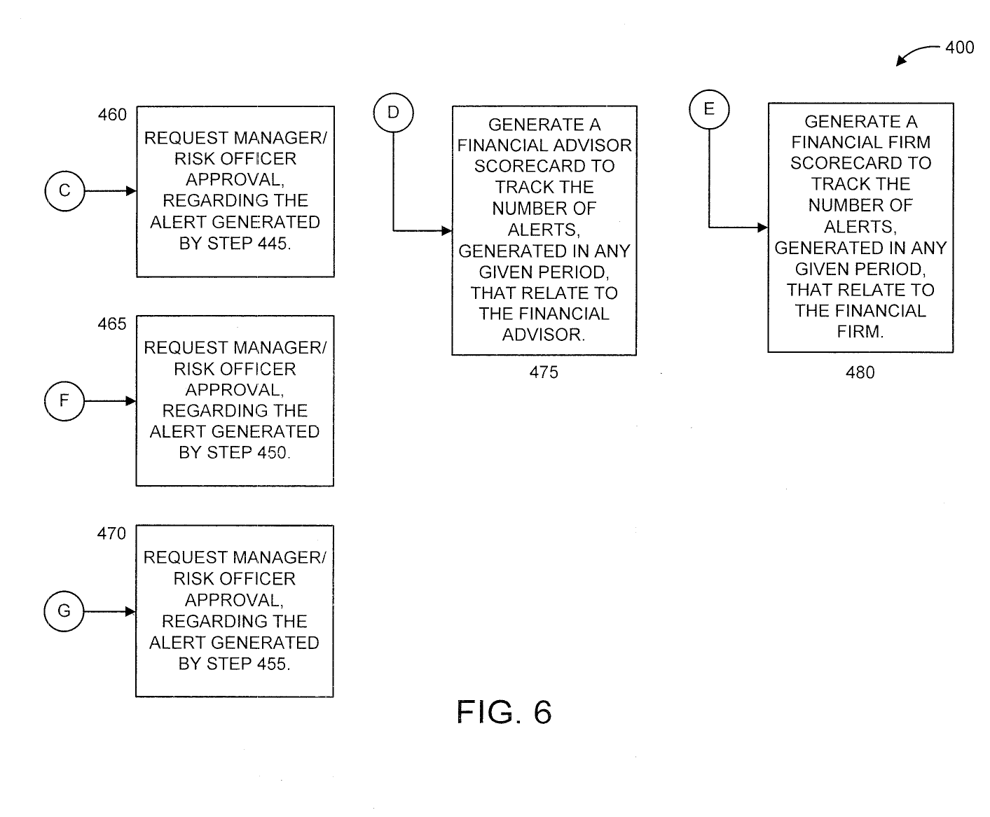

Further, it is to be appreciated that processing system 200 may perform at least part of the method described herein including, for example, at least part of method 400 of FIGS. 4-6. Similarly, part or all of system 300 may be used to perform at least part of method 400 of FIGS. 4-6.

FIG. 3 is a block diagram showing an exemplary data processing system 300 for portfolio risk management, in accordance with an embodiment of the present principles. The system 300 includes a user defined risk threshold manager 310, a risk performance calculator 320, a moving average relationships risk model generator 330, an alarm generator 340, a financial advisor scorecard generator 350, a financial firm scorecard generator 360, and a dashboard manager 370. In the embodiment of FIG. 3, elements 310 through 340 are interconnected via a system bus 302. However, in other embodiments, different connections and configurations of these elements can also be used, while maintaining the spirit of the present principles.

The user defined risk threshold manager 310 receives and manages respective user defined risk thresholds. The respective user defined risk thresholds can be for one or more of the financial account level, primary account owner level, and household level.

The risk performance calculator 320 calculates risk performance of one or more of a financial advisor, manager, and a risk/compliance officer. In an embodiment, the risk performance calculator 320 is a time-triggered risk performance calculator that calculates risk performance on one or more time bases.

The moving average model generator 330 generates a moving average model that is compared to the respective user defined risk thresholds to determine whether one or more corresponding alarm flows should be initiated.

The alarm generator 340 generates one or more corresponding alarm flows for one or more of the financial advisor, the manager, and the risk/compliance officer to ensure timely financial account holding review thereby. In an embodiment, the alarm generator 340 is a machine-based alarm generator.

The financial advisor scorecard generator 350 generates a financial advisor scorecard. The financial advisor scorecard can be based on the number of alerts generated for the financial advisor in any given time period.

The financial firm scorecard generator 360 generates a financial firm scorecard. The financial firm scorecard can be based on the number of alerts generated for the financial firm in any given time period.

While shown as separate elements, it is to be appreciated that the functions described herein with respect to the financial advisor scorecard generator 350 and the financial firm scorecard generator 360 can be implemented in a single device. Thus, any of the financial advisor scorecard generator 350 and the financial firm scorecard generator 360 can be interchangeably referred to as a “scorecard generator”.

The dashboard manager 370 generates and/or otherwise provides a dashboard or information for display on a dashboard, and manages the dashboard.

In an embodiment, at least the time-triggered risk performance calculator 320 and the moving average model generator 330 are processor-based. However, in other embodiments, other elements of system 300 can be processor-based. In yet other embodiments, one or more processors accessible by one or more of the elements of system 300 can be used. These and other variations of the processing system 300 are readily contemplated by one of ordinary skill in the art given the teachings of the present principles provided herein.

FIGS. 4-6 are flowcharts showing an exemplary method 400 for managing portfolio risk, in accordance with an embodiment of the present principles.

At step 405, the financial advisor collects from an investor client (hereinafter “client”) respective risk acceptance values at a financial account level, a contact (individual) level, and a household level. The financial advisor sets these respective risk acceptance values as target RICs for the financial account level, the contact (individual) level, and the household level. The RICs collected from the client are interchangeably referred to herein as “target RICs”.

At step 410, a compliance/risk officer defines companywide risk tolerance parameters based on the respective client risk acceptance values at the financial account level, the contact (individual) level, and the household level.

At step 415, the client financial account is downloaded, and financial account data 122, contact (individual) data 123, and household data 124 are created/updated.

At step 420, various moving average values are calculated for all holdings based on respective end-of-day (EOD) prices therefor.

At step 425, the financial account, contact (individual), and household calculated Risk Index Codes (RICs) are computed based on the defined moving average model selected by the compliance/risk officer.

At step 430, it is determined whether or not a client's financial account calculated RIC>target (financial account) RIC. If so, then the method proceeds to step 445. Otherwise, the method returns to step 415.

At step 435, it is determined whether or not a client's contact calculated RIC>target (client) RIC. If so, then the method proceeds to step 450. Otherwise, the method returns to step 415.

At step 440, it is determined whether or not a client's household calculated RIC>target (household) RIC. If so, then the method proceeds to step 455. Otherwise, the method returns to step 415.

At step 445, an alert is generated for the financial advisor (regarding the client's financial account RIC being exceeded) and the financial advisor total trigger amount is updated.

At step 450, an alert is generated for the financial advisor (regarding the client's contact RIC being exceeded) and the financial advisor total trigger amount is updated.

At step 455, an alert is generated for the financial advisor (regarding the client's household RIC being exceeded) and the financial advisor total trigger count is updated.

At step 460, manager/risk officer approval is requested, regarding the alert generated by step 445.

At step 465, manager/risk officer approval is requested, regarding the alert generated by step 450.

At step 465, manager/risk officer approval is requested, regarding the alert generated by step 455.

At step 475, a financial advisor scorecard is generated to track the number of alerts, generated in any given period, that relate to the financial advisor.

At step 480, a financial firm scorecard is generated to track the number of alerts, generated in any given period, that relate to the financial firm.

A description will now be given regarding business objectives of the present principles, in accordance with an embodiment of the present principles.

The present principles define a firm-wide holding risk model (relationships risk model) to monitor clients' assets from any of overall holding, financial account, individual and household perspectives. The present principles are designed to establish a uniform method of calculating risk across these perspectives. The present principles allow a rep/advisor to define risk level based on, for example, “know-your-client info” and in conjunction with the compliance officer's perspective of security risk. The present principles allow the financial firm to monitor client acceptable risk tolerance and ensure that an alert is generated if it exceeds the defined threshold. These and other business objectives capable of being realized by the present principles are readily determined by one of ordinary skill in the art given the teachings of the present principles provided herein.

A description will now be given regarding setup options of implementations of the present principles, in accordance with an embodiment of the present principles.

Regarding a setup option, an Assets Under Management (AUM) minimum definition can be provided at one or more of the following levels: firm level; branch level; and advisor level. Regarding another setup option, one or more exclusions per financial account can be used. Regarding yet another setup option, the financial advisor can be allowed to manually set the next review days or subject to standard next review days. It is to be appreciated that the present principles are not limited to the preceding setup options and, thus, other setup options can also be used in accordance with the teachings of the present principles provided herein, while maintaining the spirit of the present principles. Moreover, while described as setup options, of course the preceding options can be implemented in various embodiments of the present principles at times subsequent to an initial setup time.

A description will now be given regarding data sources capable of being used by the present principles, in accordance with an embodiment of the present principles.

In an embodiment, holding data can be used by the present principles. TABLE 1 shows exemplary types of holding data capable of being used by the present principles. Of course, the present principles are not limited to solely the following types of holding data and, thus, other types of holding data can also be used in accordance with the teachings of the present principles, while maintaining the spirit of the present principles.

TABLE 1

| Object type | source | frequency | notes |
|---|---|---|---|
| Account | Can be non-user generated | As required | Aka household |
| | or user defined | | |
| Contact | Controlled by SSN/TIN | As required | Aka individual |
| Financial | Back-office | Daily | |
| account | | | |
| Holding | Back-office | Daily | |
| SecuMaster | Back-office | Daily | |
| | Derived from holding with | | |
| | cusip as the key | | |

In an embodiment, pricing history for each SecurityMaster 141 (also interchangeably referred to herein as “SecuMaster”) can be used as a key element. In an embodiment, we can use end-of-day (EOD) pricing data to compute various pricing variance factors.

A description will now be given regarding data setup, in accordance with an embodiment of the present principles.

In an embodiment, data setup can involve at least some of the following:

### 1. Load Financial Account;

### 2. Load Holding;

### 3. Load SecuMaster and Link to Holding;

4. Define Security Risk Index (SRI) for each SecuMaster by compliance office;
5. Define FA Risk Index (FARI) for each financial account by rep/advisor;
6. Define Client Risk Index (CRI) for each client by rep/advisor; and
7. Define Household Risk Index (HRI) for each household by rep/advisor.

A description will now be given regarding defining Secumaster 141, in accordance with an embodiment of the present principles. The following description uses certain data objects. However, other embodiments can involve the same or different data objects, different data structures, and so forth, while maintaining the spirit of the present principles. For the sake of illustration, the object names are essentially indicative of function.

The primary security master table can be located in an eoddata.stock object. We will use data in eoddata to compute 60/180/365 moving averages. Of course, other time bases can also be used. The current data set from eoddata can include, for example, but is not limited to, one or more of the following: equity (NYSE) (AMEX) (NASDAQ); index; option; and mutual fund.

Each night after we download data from the EODDATA website, we will compute the 50/100/365 moving averages based on the current data set. Of course, other time bases can also be used. The summary data can be stored in an eoddata.mavg object.

In an embodiment, the present principles can be implemented in a service hereinafter interchangeably referred to as “AppKnight” and “the service”. For example, the service can be provided by the system or the method of the present principles. However, other implementations can also be used in accordance with the teachings of the present principles. Each client who subscribes to the service, and/or otherwise uses the present principles, will have its local SecuMaster last price file checked against the eoddata.stock object. If the record does not exist, then a new record will be created. The moving average (MAVG) process will be applied to the stock and update the eoddata.mavg object.

After the processing has been confirmed for the client, the current eoddata.mavg data can be copied back to a salesforce.EAST_SecurityMaster_c object saved under X50MAVG_c, X100MAVG_c, and X365MAVG_c fields corresponding to 50/100/365 moving averages, respectively.

Each firm and client will define its own Portfolio Risk Exposure (PRE) ratio by a RIC as follows:

1=30% (very conservative)
2=35% (conservative)
3=40% (moderate)
4=50% (aggressive)
5=60% (hedging)

Each household (HH), individual (Indv), and financial advisor (FA) can have its RIC defined. You can define it at the financial advisor level or at the individual level or at the household level. The backend processing will scan all defined records and perform processing accordingly.

A description will now be given regarding moving average calculation and upload, in accordance with an embodiment of the present principles. The description will address sources for calculating the moving average and historical data build up.

In an embodiment, there are 2 sources for calculating a moving average, namely end-of-day (EOD) stock pricing and existing holding price. Of course, other embodiments can involve other sources while maintaining the spirit of the present principles.

Regarding end-of-day stock pricing, this source provides information on all domestic stocks. The data can be uploaded to a particular website/webpage/server/etc. for use in accordance with the present principles.

Regarding existing holding price, in particular, for holding securities that are not domestic stock, we will need to get the last price from the client's holding records. The processing will need to extract data from the holding's last price and transfer it to a database, for example, to a Structured Query Language's (SQL's) eoddata.stock record. After the transfer is completed, the same processing module can be used to calculate the 50-100-365 moving averages to the company SecuMaster records.

Regarding historical data build up, in order to create a good starting environment for clients using the present principles, we will attempt to extract historical pricing data from history data files in a position data directory. The directory should include historical price within the position data. In an embodiment, a special program can be used for this purpose. The program can be configured to look for a symbol (if not a symbol then, e.g., a cusip, a security ID, etc.) and upload the date-price, e.g., to the SQL's eoddata.stock object.

A description will now be given regarding a holding risk definition and alerting, in accordance with an embodiment of the present principles.

RICs can be defined at the following levels: firm level; and firm and user level.

At the firm level, each RIC can be defined to use a particular MAVG (e.g., from among a set of MAVGs) to compare against the last price. Of course, each RIC can be compared to more than one MAVG. Example correlations are as follows:
RIC1MAVG_c, RIC2MAVG_c, RIC3MAVG_c=365 MAVG
RIC4MAVG_c=180 MAVG
RIC5MAVG_c=90 MAVG

At the firm and user level, each RIC portfolio risk percentage (PRE) can be defined as RICxPRE_c. It is to be appreciated that the terms “portfolio risk percentage” and “likely loss ratio” are used interchangeably herein. The PRE is calculated by comparing each holding's last price versus the selected MAVG and if lastprice<MAVG, then the percentage of holding value/total portfolio value is added to PRE. If the current portfolio's PRE is greater than the appropriate RICXPRE, then an alert is generated. Example correlations are as follows:
RIC1PRE_c=10%; RIC2PRE_c=20%; RIC3PRE_c=30%; RIC4PRE_c=40%; RIC5PRE_c=50%.

An example is now described of a portfolio of 3 holdings, in accordance with an embodiment of the present principles.

100 shares of IBM with MAVG=190 and lastprice=183
1000 shares of GE with MAVG=19 and lastprice=21
300 shares of APPL with MAVG=89 and lastprice=98

The IBM shares are worth 26.6% of the portfolio and their lastprice is less than the MAVG. Hence, the PRE is 26.6%.

If the client has selected RIC2PRE_c as its threshold, than an alert will be generated. Or, if the client has selected RIC3PRE_c as its threshold, then no alert will be generated.

An example is now described of a portfolio of 2 holdings, in accordance with an embodiment of the present principles.

ABC->lastprice=90; 365 MAVG=88 & portfolio pct=60%
XYZ->lastprice=40; 365 MAVG=42 & portfolio pct=40%

The calculated PRE is 40%. With this PRE, the RIC of 1, 2 and 3 will be alerted. The RIC of 4 and 5 will not be alerted.

Once an alert is triggered, the trigger date is saved. In an embodiment, it can be saved in RICLastTriggered_c. The minimum gap or span days can be defined, e.g., in RICTriggerMinSpanDays_c. This means that the next alert will be generated at minimum (RICTriggerMinSpanDays) days after the RICLastTriggered_c.

FIG. 7 is a flow diagram further showing step 430 of FIG. 4, in accordance with an embodiment of the present principles. Step 430 relates to determining whether a portfolio loss is imminent at the financial account level.

At step 710, a last price (e.g., EOD price) of a financial account (financial account level) is compared against a corresponding moving average calculated therefor

At step 720, it is determined whether the last price is less than the corresponding moving average (MAVG). If so, then the method proceeds to step 730. Otherwise, the method returns to step 710. It is to be appreciated that in an embodiment, the returning to step 710 may be implemented in accordance with a time-basis such as, for example, nightly.

At step 730, a holding to portfolio ratio is added to a RIC portfolio risk percentage for the financial account level. The RIC PRE is also referred to herein as a likely loss ratio.

At step 740, it is determined whether or not the likely loss ratio exceeds a maximum projected % asset loss per financial account level risk category. If so, the method proceeds to step 445 in FIG. 4. If not, the method proceeds to step 750.

At step 750, it is determined whether or not the number of negative trending days of the likely loss ratio exceeds a threshold number of negative trending days per financial account level risk category. If so, the method proceeds to step 445 in FIG. 4. If not, the method returns to step 415 in FIG. 4.

Regarding step 740, the likely loss ratio corresponds to the calculated RIC for the financial account level risk category (per step 425 of FIG. 4), and the maximum projected % asset loss per financial account level risk category corresponds to the target RIC for the financial account level risk category (per step 405 of FIG. 4).

Regarding step 750, the number of negative trending days of the likely loss ratio also corresponds to the calculated RIC for the financial account level risk category (per step 425 of FIG. 4), and the threshold number of negative trending days per financial account level risk category also corresponds to the target RIC for the financial account level risk category (per step 405 of FIG. 4).

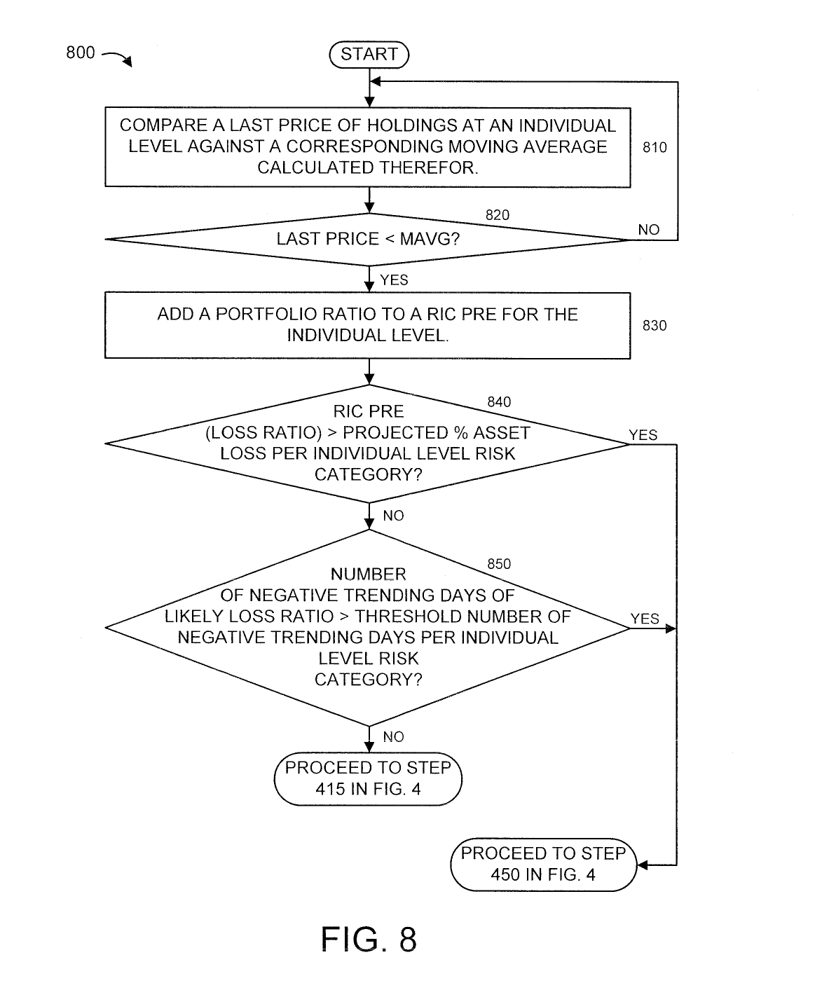

FIG. 8 is a flow diagram further showing step 435 of FIG. 4, in accordance with an embodiment of the present principles. Step 435 relates to determining whether a portfolio loss is imminent at the individual level.

At step 810, a last price (e.g., EOD price) of holdings at an individual level is compared against a corresponding moving average calculated therefor

At step 820, it is determined whether the last price is less than the corresponding moving average (MAVG). If so, then the method proceeds to step 830. Otherwise, the method returns to step 810. It is to be appreciated that in an embodiment, the returning to step 810 may be implemented in accordance with a time-basis such as, for example, nightly.

At step 830, a holding to portfolio ratio is added to a RIC portfolio risk percentage for the individual level. The RIC PRE is also referred to herein as a likely loss ratio.

At step 840, it is determined whether or not the likely loss ratio exceeds a maximum projected % asset loss per individual level risk category. If so, the method proceeds to step 450 in FIG. 4. If not, the method proceeds to step 850.

At step 850, it is determined whether or not the number of negative trending days of the likely loss ratio exceeds a threshold number of negative trending days per individual level risk category. If so, the method proceeds to step 450. If not, the method returns to step 415.

Regarding step 840, the likely loss ratio corresponds to the calculated RIC for the individual level risk category (per step 425 of FIG. 4), and the maximum projected % asset loss per individual level risk category corresponds to the target RIC for the individual level risk category (per step 405 of FIG. 4).

Regarding step 850, the number of negative trending days of the likely loss ratio also corresponds to the calculated RIC for the individual level risk category (per step 425 of FIG. 4), and the threshold number of negative trending days per individual level risk category also corresponds to the target RIC for the individual level risk category (per step 405 of FIG. 4).

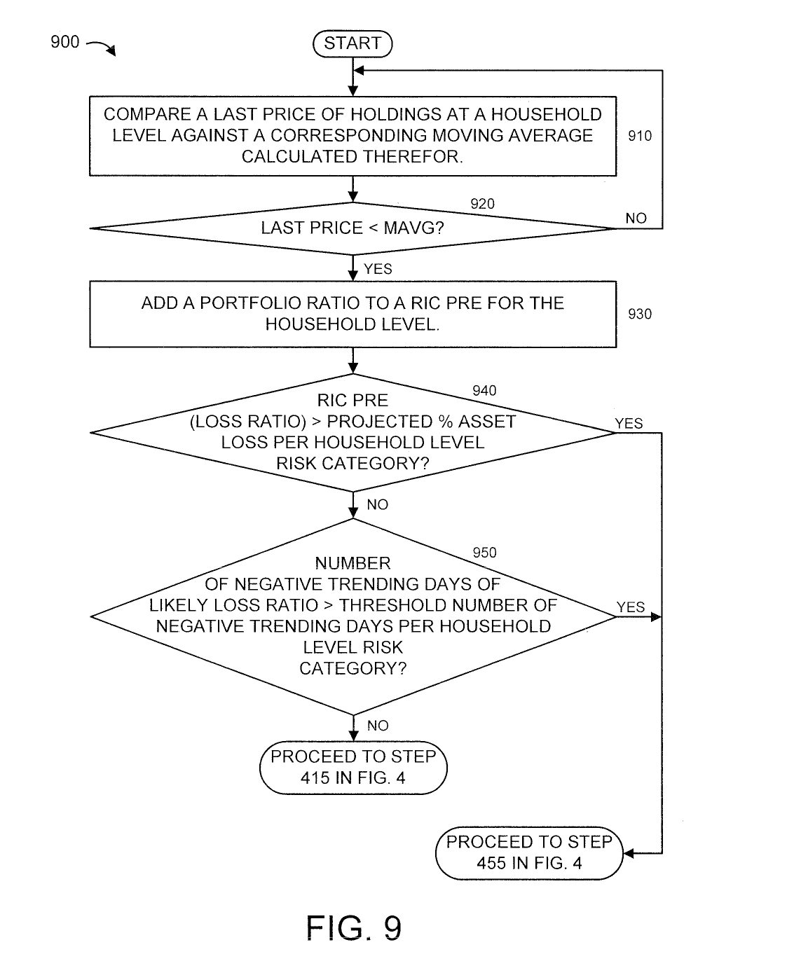

FIG. 9 is a flow diagram further showing step 440 of FIG. 4, in accordance with an embodiment of the present principles. Step 440 relates to determining whether a portfolio loss is imminent at the household level.

At step 910, a last price (e.g., EOD price) of holdings at a household level is compared against a corresponding moving average calculated therefor

At step 920, it is determined whether the last price is less than the corresponding moving average (MAVG). If so, then the method proceeds to step 930. Otherwise, the method returns to step 910. It is to be appreciated that in an embodiment, the returning to step 910 may be implemented in accordance with a time-basis such as, for example, nightly.

At step 930, a holding to portfolio ratio is added to a RIC portfolio risk percentage (PRE) for the household level. The RIC PRE is also referred to herein as a likely loss ratio.

At step 940, it is determined whether or not the likely loss ratio exceeds a maximum projected % asset loss per defined household level risk category. If so, the method proceeds to step 455 in FIG. 4. If not, the method proceeds to step 950.

At step 950, it is determined whether or not the number of negative trending days of the likely loss ratio exceeds a threshold number of negative trending days per a predefined household level risk category. If so, the method proceeds to step 455 in FIG. 4. If not, the method returns to step 415 in FIG. 4.

Regarding step 940, the likely loss ratio corresponds to the calculated RIC for the household level risk category (per step 425 of FIG. 4), and the maximum projected % asset loss per household level risk category corresponds to the target RIC for the household level risk category (per step 405 of FIG. 4).

Regarding step 950, the number of negative trending days of the likely loss ratio also corresponds to the calculated RIC for the household level risk category (per step 425 of FIG. 4), and the threshold number of negative trending days per household level risk category also corresponds to the target RIC for the household level risk category (per step 405 of FIG. 4).

A description will now be given regarding alert outputs, in accordance with an embodiment of the present principles.

We can create an alert event and generate an output (e.g., in portable document format (PDF) or any other format) to describe the alert detail. We can send an email to the financial advisor. We can integrate an alert with a service monitor. Then, when a household or client has an outstanding alert, the service monitor can provide an alert indication to the client. For example, in an embodiment, the household or client record will display a flashing Red icon. Of course, other alert indicators can also be used in accordance with the teachings of the present principles, while maintaining the spirit of the present principles.

A description will now be given regarding model management and alerting, in accordance with an embodiment of the present principles.

The present principles can monitor portfolio concentration risk and allocation risk by defining security master asset type and model definition based on asset type.

With the financial account security portfolio concentration percentage defined, it is possible to identify a financial advisor, an individual, or a household with a high concentration of one stock, or one asset type.

With the model definition, it is possible to compare a financial advisor, an individual, or a household with a model(s) to identify an above allocation threshold for the financial advisor, the individual, or the household.

A description will now be given regarding alert management, in accordance with an embodiment of the present principles.

It is to be appreciated that the present principles support multiple levels of alert monitoring including, but not limited to, one or more of the following: firm level; branch level; rep/advisor level; household level; and individual level.

In an embodiment, the monitoring hierarchy can be as follows:

### -[Financial Account]

### --[Individual]

### ---[Household]

### ----[Financial Advisor]

### -----[OSJ/Branch]

### ------[Home Office Compliance Officer].

In an embodiment, a lower level of monitor can override a higher level of monitor. For example, if an individual client has a client risk code of 3, then it will be overridden by a household risk code of 2. Likewise, a financial advisor with a risk code of 1 will override a client risk code of 3.

When an alert is generated, the alert record is assigned to the rep/advisor user and it will automatically generate an approval request to his/her delegated approver. If an alert is not cleared within a certain time period (e.g., but not limited to 3 days), then it is escalated to the compliance officer.

A description will now be given regarding reporting, in accordance with an embodiment of the present principles.

Reporting can involve many items described herein. In an embodiment, some of the items that can be reported include, but are not limited to, the following:

### 1. Suitability of Portfolio—Concentration Risk

### 2. Asset Allocation Model (AAL)

### 3. SecuMaster Risk Index Alert due to Price Movement>(+−) 10%, 20%, and 30%

4. FA with FA Risk Discrepancy PCT>(+−) 10%, 20%, and 30%
5. Individual with Client Risk Discrepancy PCT>(+−) 10%, 20%, and 30%
6. Household with Household Risk Discrepancy PCT>(+−) 10%, 20% and 30%
7. Rep/Advisor having FA, Client and HH Risk Discrepancy PCT>(+−) 10%, 20% and 30%
8. Branch having FA, Client and HH Risk Discrepancy PCT>(+−) 10%, 20% and 30%
9. Firm count of FA, Client and HH Risk Discrepancy PCT>(+−) 10%, 20% and 30%

Of course, the preceding incremental amounts are merely illustrative and other amounts can be used, while maintaining the spirit of the present principles.

A description will now be given of some of the features/advantages of the present principles.

In an embodiment, we compute user-defined moving average values for all client holdings. External historical data is not required since we receive daily end-of-day holding prices.

In an embodiment, we store a computed moving average value as a set of historical comparison data points.

In an embodiment, the compliance/risk officer defines a firm wide portfolio risk metric (RIC) with the following key data points: risk category code; assign a moving average day code per risk category; maximum projected % asset loss allowed per risk category; and number of negative trending days allowed per risk category.

In an embodiment, the financial advisor needs to define for each financial account, each client, and each household, a risk metric code (RIC) based on the definition of company compliance/risk officer.

The present principles perform key computation and actions based on the conditions specified below.

For example, for a financial account, the following is performed. Based on the assigned financial account risk category (RIC), we compute the appropriate moving average value and calculate a likely loss ratio for the whole financial account. If the loss ratio for the whole financial account exceeds the maximum projected % asset loss per defined financial account risk category, then an alert record is created. Moreover, if the loss ratio negative trending days exceed the number of negative trending days per financial account risk category, then an alert is created.

For a client, the following is performed. Based on the assigned client risk category (RIC), we compute the appropriate moving average value and calculate a likely loss ratio for the client. If the loss ratio for the client exceeds the maximum projected % asset loss per defined client risk category, then an alert record is created. Moreover, if the loss ratio negative trending days exceed the number of negative trending days per client risk category, then an alert is created.

For a household, the following is performed. Based on the assigned household risk category (RIC) compute the appropriate moving average value and calculate a likely loss ratio for the whole household. If the loss ratio for the whole household exceeds maximum projected % asset loss per defined household risk category, then an alert record is created. Moreover, if the loss ratio negative trending days exceed the number of negative trending days per household risk category, then an alert is created.

A description will now be given regarding risk workflow setup, in accordance with an embodiment of the present principles.

Depending on the severity of alerts and frequency of recurrence, compliance/risk office can define three (3) levels of alert workflows as follows.

We have a level 1 alert, where the compliance/risk officer can define what is a level 1 alert. For a level 1 alert, the following is performed: (1) the alert is sent to the financial advisor for review; (2) the financial advisor performs the appropriate action(s) (e.g., call the client and review or accept alert and wait for next alert before action); (3) send a description of such actions to a manager for approval; and (4) the manager sends such actions to the compliance/risk officer for approval if needed.

We have a level 2 alert, where the compliance/risk officer can define what is a level 2 alert. For a level 2 alert, the following is performed: (1) the alert is sent to the manager for review; (2) the manager enters review comments and sends to the financial advisor for action; (3) the financial advisor performs contact action and records client interactions then sends back to the manager for approval; and (4) the manager approves the financial advisor interaction and forwards to the compliance/risk officer if needed.

We have a level 3 alert, where the compliance/risk officer can define what is a level 3 alert. For a level 3 alert, the following is performed: (1) the alert is sent to the compliance/risk manager for review; (2) the compliance/risk manager enters review comments and sends to the financial advisor for action; (3) the financial advisor performs contact action and records client interactions then sends back to the compliance/risk officer for approval; and (4) the compliance/risk officer approves the financial advisor interaction and forwards to the branch manager for acknowledgement.

Of course, more or less alert levels than three can be used, while maintaining the spirit of the present principles. Moreover, different actions can be performed and different individuals involves, for any of the alert levels. These and other variations to the alerts described herein are readily contemplated by one of ordinary skill in the art given the teachings of the present principles provided herein, while maintaining the spirit of the present principles.

In an embodiment, a loss tracker tracks the number of recurrences and frequency of recurrence within a time period. If the RIC score falls below a defined threshold N times over M periods, where N and M are integers, then special attention is given to the offending financial advisor. Such recurrence would indicate serious portfolio risk is imminent and corrective action and client notification is required.

In an embodiment, a dashboard can display RIC indices at the firm, region, branch, and financial advisor levels. The dashboard can present calculations of overall client potential loss amount versus total AUM at the firm, region, branch, and financial advisor level. A monitor lets the firm chief executive officer (CEO) or other authorized individual(s) visualize potential loss exposure due to commonly known security market pricing theory. Furthermore, the monitor correlates financial advisor outreach notes versus potential loss exposure. The system can provide the CEO and the chief compliance office (CCO) an indication of potential arbitration cases the firm may have to deal with due to lack of client outreach from market value fluctuation and the resulting portfolio loss.

In an embodiment, a financial advisor report card shows per financial advisor RIC triggers by month, quarter, semi-annual and annual basis. Additional comparisons of same month last year versus this month, same quarter last year versus this quarter, and this year versus last year are available to management to determine risk taking behavior of a financial advisor. Of course, other comparisons can also be used, while maintaining the spirit of the present principles.

It has been noted herein that the present principles can be implemented as a service. In an embodiment, the service can be implemented as a cloud service. Accordingly, implementations of the present principles can include one or more of a service (e.g., Software as a Service (SaaS)), a platform (e.g., Platform as a Service (PaaS)), and infrastructure (Infrastructure as a Service (IaaS)) to support a cloud configuration whereby the service can be downloaded into a user's computer. Calculations, alerts, and other aspects of the present principles can be performed in the cloud with the results, where applicable, are disseminated to one or more pre-designated individuals including, but not limited to, the user, the financial advisor, a manager, a compliance officer, a CEO, and so forth. In an embodiment, the interface between the service and the user can be implemented using a dashboard. These and other implementations of the present principles are readily determined by one of ordinary skill in the art given the teachings of the present principles provided herein, while maintaining the spirit of the present principles.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method, comprising:
calculating, using a processor-based moving average model generator, respective moving average values for client holdings at a financial account level, an individual client level, and a household level based on end-of-day holding prices therefor;
calculating a financial account level risk metric, an individual level risk metric, and a household level risk metric responsive to the respective moving average values; and
outputting a respective machine-generated alarm signal for at least one financial firm employee responsive to any of the financial account level risk metric, the individual level risk metric, and the household level risk metric respectively exceeding a target financial account level risk metric, a target individual level risk metric, and a target household level risk metric, the target risk metrics being determined from respective client specified risk acceptance values at the financial account level, the individual client level, and the household level.

2. The method of claim 1, wherein said outputting step comprises transforming an amount of excess between any of, the financial account level risk metric and the target financial account level risk metric, the individual level risk metric and the target household level risk metric, and the household level risk metric and the target individual level risk metric, into the respective machine-generated alarm signal.

3. The method of claim 1, further comprising updating at least one of a financial advisor level alert count and a financial firm level alert count responsive to the respective machine-generated alarm signal being output.

4. The method of claim 1, further comprising generating at least one of a financial advisor scorecard and a financial firm scorecard to track a number of respective machine-generated alarm signals that are output.

5. The method of claim 4, further comprising tracking numbers of alarm recurrence and frequency of alarm recurrence within a given time period in a scorecard score, wherein a corresponding financial advisor is negatively flagged and a corresponding portfolio loss is flagged as being imminent responsive to the scorecard score falling below a defined threshold N times over M periods, wherein N and M are integers.

6. The method of claim 1, further comprising generating an override request and forwarding the override request to an override authorization financial firm employee responsive to the respective machine-generated alarm signal being output.

7. The method of claim 1, wherein the financial account level risk metric, the individual level risk metric, and the household level risk metric are calculated further responsive to a financial firm specified firm-wide risk index.

8. The method of claim 7, wherein the financial firm specified firm-wide risk index is determined responsive to the respective client specified risk acceptance values at the financial account level, the individual client level, and the household level.

9. The method of claim 1, wherein the financial account level risk metric, the individual level risk metric, and the household level risk metric are calculated further responsive to a last holding price at the financial account level, the individual client level, and the household level.

10. The method of claim 1, further comprising providing a dashboard for displaying on a display device, the dashboard specifying respective risk indexes at a firm level, a region level, a branch level, and a financial advisor level for client holdings relating thereto.

11. The method of claim 1, wherein each of the financial account level risk metric, the individual level risk metric, and the household level risk metric are calculated as a respective likely loss ratio for the financial account level, the individual level, and the household level.

12. The method of claim 11, wherein the respective machine-generated alarm signal is output responsive to the respective likely loss ratio for any of the financial account level, the individual level, and the household level exceeding a respective one of the target risk metrics at a same level, each of the target risk metrics being represented as a respective threshold maximum projected percentage of asset loss per a level-based risk category.

13. The method of claim 11, wherein the respective machine-generated alarm signal is output responsive to a number of negative trending days of the respective likely loss ratio for any of the financial account level, the individual level, and the household level exceeding a respective one of the target risk metrics at a same level, each of the target risk metrics being represented as a respective threshold number of negative trending days per a level-based risk category.

14. The method of claim 1, wherein said outputting step comprises outputting at least one of a plurality of different levels of the respective machine-generated alarm signal responsive to which ones of the target financial account level risk metric, the target individual level risk metric, and the target household level risk metric are exceeded.

15. The method of claim 14, wherein each of the plurality of different levels, starting at a lowest level corresponding to the financial account level can override a higher level with respect thereto.

16. The method of claim 1, wherein the method is provided as a service in a cloud environment.

17. A non-transitory article of manufacture tangibly embodying a computer readable program which when executed causes a computer to perform the steps of claim 1.

18. A system, comprising:
a processor-based moving average model generator for calculating respective moving average values for client holdings at a financial account level, an individual client level, and a household level based on end-of-day holding prices therefor;
a risk performance calculator for calculating a financial account level risk metric, an individual level risk metric, and a household level risk metric responsive to the respective moving average values; and
an alarm generator for outputting a respective alarm signal for at least one financial firm employee responsive to any of the financial account level risk metric, the individual level risk metric, and the household level risk metric respectively exceeding a target financial account level risk metric, a target individual level risk metric, and a target household level risk metric, the target risk metrics being determined from respective client specified risk acceptance values at the financial account level, the individual client level, and the household level.

19. The system of claim 18, wherein said alarm generator transforms an amount of excess between any of, the financial account level risk metric and the target financial account level risk metric, the individual level risk metric and the target household level risk metric, and the household level risk metric and the target individual level risk metric, into the respective machine-generated alarm signal.

20. The system of claim 18, further comprising a scorecard generator for updating at least one of a financial advisor level alert count and a financial firm level alert count responsive to the respective machine-generated alarm signal being output.

21. The system of claim 18, further comprising a scorecard generator for generating at least one of a financial advisor scorecard and a financial firm scorecard to track a number of respective machine-generated alarm signals that are output.

22. The system of claim 21, wherein said scorecard generator tracks numbers of alarm recurrence and frequency of alarm recurrence within a given time period in a scorecard score, wherein a corresponding financial advisor is negatively flagged and a corresponding portfolio loss is flagged as being imminent responsive to the scorecard score falling below a defined threshold N times over M periods, wherein N and M are integers.

23. The system of claim 18, wherein said alarm generator generates an override request and forwards the override request to an override authorization financial firm employee responsive to the respective machine-generated alarm signal being output.

24. The system of claim 18, wherein the financial account level risk metric, the individual level risk metric, and the household level risk metric are calculated further responsive to a financial firm specified firm-wide risk index.

25. The system of claim 24, wherein the financial firm specified firm-wide risk index is determined responsive to the respective client specified risk acceptance values at the financial account level, the individual client level, and the household level.

26. The system of claim 18, wherein the financial account level risk metric, the individual level risk metric, and the household level risk metric are calculated further responsive to a last holding price at the financial account level, the individual client level, and the household level.

27. The system of claim 18, further comprising a dashboard manager for providing a dashboard for displaying on a display device, the dashboard specifying respective risk indexes at a firm level, a region level, a branch level, and a financial advisor level for client holdings relating thereto.

28. The system of claim 18, wherein each of the financial account level risk metric, the individual level risk metric, and the household level risk metric are calculated as a respective likely loss ratio for the financial account level, the individual level, and the household level.

29. The system of claim 28, wherein the respective machine-generated alarm signal is output responsive to the respective likely loss ratio for any of the financial account level, the individual level, and the household level exceeding a respective one of the target risk metrics at a same level, each of the target risk metrics being represented as a respective threshold maximum projected percentage of asset loss per a level-based risk category.

30. The system of claim 28, wherein the respective machine-generated alarm signal is output responsive to a number of negative trending days of the respective likely loss ratio for any of the financial account level, the individual level, and the household level exceeding a respective one of the target risk metrics at a same level, each of the target risk metrics being represented as a respective threshold number of negative trending days per a level-based risk category.

31. The system of claim 18, wherein said alarm generator outputs at least one of a plurality of different levels of the respective machine-generated alarm signal responsive to which ones of the target financial account level risk metric, the target individual level risk metric, and the target household level risk metric are exceeded.

32. The system of claim 31, wherein each of the plurality of different levels, starting at a lowest level corresponding to the financial account level, can override a higher level with respect thereto.
